(19) United States
(12) Patent Application Publication
(10) Pub. No.: US 2007/0277657 A1
(43) Pub. Date: Dec. 6, 2007

(54) SHADE CUTTER

(76) Inventors: Dennis J. Hilgendorf, Stoughton, WI (US); David A. Hilgendorf, Madison, WI (US); David A. Rynes, Stoughton, WI (US)

Correspondence Address: DEWITT ROSS & STEVENS S.C.;Intellectual Property Department, US Bank Building, Suite 401, 8000 Excelsior Drive, Madison, WI, 53717-1914, US

(21) Appl. No.: 11/753,756

(22) Filed: May 25, 2007

Related U.S. Application Data
(60) Provisional application No. 60/808,741, filed on May 26, 2006.

(51) Int. Cl. B26D 1/00

(52) U.S. Cl. 83/13; 83/651

(57) ABSTRACT

A shade cutter for trimming rotating window shades includes a larger opening to accommodate larger diameter shades, one blade for cutting both the slat and the shade, a mechanism to remove the shade pin, a protective cover for the blade, and a motor contained in the shade cutting machine base.

### REFERENCE TO RELATED APPLICATION

The application claims priority to U.S. Provisional Application entitled “Shade Cutter,” Ser. No. 60/808,741, filed May 26, 2006, which is incorporated herein by reference in its entirety.

### FIELD OF THE INVENTION

The present invention is directed to a machine for trimming rotating window shades.

### DESCRIPTION OF THE PRIOR ART

Shade cutters have been around for many years. The primary purpose of a shade cutter is to cut a window shade to a precise dimension. In this manner, a standard length window shade can be formed in the factory and then sent to the customer or customer's shop for measurement and trimming if necessary.

There are some issues with the prior art shade cutters though. For example, the shade cutter opening is typically too small. Newer shades are made with different materials and/or insulated which increases the diameter and makes the older shade cutter models inoperable. Further, the prior art machines have a guillotine type cutting blade to cut the slat, which is a safety problem. Further still, the shade pieces, i.e., the cast offs, which are coming off of the machine after the shade has been cut, can fly off in a variety of directions and create a safety problem. In addition, the cutting blade is readily accessible to the operator, creating a safety problem during the cutting operation.

### SUMMARY OF THE INVENTION

The present invention overcomes these and other issues associated with prior art shade cutters with a new, useful and unobvious device as described and claimed in the following paragraphs.

Referring now to the drawings, the present invention is directed to a shade cutter assembly device 10 for trimming a rotating window shade 200 (illustrated in FIG. 10) to a precise dimension. Referring to FIG. 1, the shade cutter assembly device 10 comprises a shade support measuring rail 12 having a first end 14 and a second end 16 and which is supported on a base 18 by supports 19.

As illustrated in FIG. 1a, the rail 12 is an extruded rail in the shape of a “V” with a “T” base 15 on its dorsal side for positioning the rail 12 on the base 18 by means of the shade support brackets 19. A shallow slot 13 runs the length of the rail 12 for placement of an adhesive measuring tape (not illustrated) if desired.

Further illustrated in FIG. 1 is a shade support bracket 20 slidably affixed to the rail 12 by means of glides 21, which slidably interact with the V-shaped conformation of the rail 12. The shade support bracket 20 comprises a universal inner bearing brace 22 that mates with the shade 200 having both the pin-type and tab-type shade roller ends, therefore minimizing vibrations that were seen in previous designs. The shade support bracket 20 further includes a shade support tightening handle 24 to allow flexibility in the placement of the bracket 20 along the rail 12. A spring loaded pin plunger 26 allows the shade pin 203 (FIG. 9) to be reinserted without having to move the shade support bracket 20.

Further illustrated in FIG. 1 is an optional vibration dampener 30, which is designed to stabilize the shade 200 oscillation during the cutting process. The vibration dampener 30 is mounted along the rail 12 approximately equidistant between the shade support bracket 20 and the cutting machine 40 and is adjustable for different size shades 200. The vibration dampener 30 includes counter-rotating wheels 32, 34 to maintain a pressure against the shade 200 as the shade 200 is cut, keeping the shade 200 collinear.

FIGS. 2-6 illustrate the shade cutting machine 40, which comprises a shade cutting machine base 42 and a roller shade slat support 44 for allowing both the shade 200 and the slat 202 (illustrated in FIGS. 9 and 10) to be cut in the same operation, ensuring both are the same length. The shade cutting machine 40 includes a mechanism for pulling the shade pin 203 from a shade 200 which includes a shade rest 48, a pin puller handle 50 which is activated in a 180-degree fashion in order to pull the pin (not illustrated) from the end of the shade 200, and a collet 49 within the opening 46. The collet 49 is a 4-jawed tapered device to clamp the shade pin 203 of the shade 200 on the core spindle and allow removal. The mechanism is a rack and pinion design activated by the handle 50. A thumb knob or tightener 51 tightens down the collet 49 onto the shade pin 203 on the shade 200.

The cutting machine 40 also includes a drive motor 60 which is fully enclosed in the shade cutting machine base 42 of the machine 40. The motor 60 is supported on both ends to reduce vibrations in the machine 40. One end of the motor 60 is securely fastened to the shade cutting machine base 42 with locknuts or the like. The other end of the motor 60 is secured with a removable closure cap 62 that slides over the end of the motor 60 with a press fit. The motor 60 is activated by a standard power source 61.

Referring to FIGS. 4 and 5, the machine 40 further includes a bearing assembly 70 surrounding the shade clamp assembly 71. The bearing assembly 70 comprises an insert ring 72, surrounded by a molded plastic bearing casing 74. The bearing assembly 70 further includes a slot 78 (FIG. 5) for mounting the timing belt tensioner 80. This slot 78 ensures proper belt tension at all times. A timing belt 82 and drive gear 83 are placed on the bearing casing 74 to rotate the shade clamp assembly 71. The timing belt 82 is connected to a smaller sprocket 86 on the motor 60 to rotate the bearing assembly 70.

Referring to FIGS. 6 and 7, the machine 40 includes a shade clamping assembly 71 comprising a clamping device 90 with a threadable centering clamp 92 having four centering surfaces 92a, 92b, 92c, and 92d such that the shade 200 is clamped in the central portion of the orifice 94. Therefore, the shade 200 is always clamped at the four centering surfaces 92a, 92b, 92c, and 92d.

The machine 40 further comprises a cutting blade 100 supported by a cutting blade handle 101, comprising a stationary steel blade wherein the blade is a single bevel blade. The cutting blade 100 can be rotated at intervals using the spring clip 110 to always have a sharpened portion of the blade 100. The cutting blade 100 includes a circular row of eight rectangular blade notches 109 spaced out over half the blade 100. These notches 109 are used in conjunction with a spring steel clip 110 to prevent blade 100 rotation during cutting and allow for quick and easy blade indexing. The spring steel clip 110 attaches directly between the cutting blade handle 101 and the blade 100 using a bolt 112 (illustrated in FIG. 8). The clip 110 penetrates the blade notch 109 in the blade 100. One side of the clip 110 is perpendicular to the blade notch 109, allowing the blade 100 to stay in a fixed position while cutting the shade 200. The other side of the clip 110 has been designed with a taper (not illustrated). This allows the operator, using a supplied tool 116 attached to the machine 40 by a flexible tether 118 (FIG. 2), to advance the blade 100 rotationally to the next slotted position. This exposes a new sharp cutting surface area of the circular blade 100. The blade notches 109 only cover half of the blade 100 because the other half of the blade 100 is used for cutting of the slats 202, and may be dull from that operation. Once the user reaches the end of the blade notches 109, it is time to replace the blade 100.

A cutting blade handle 101 is provided for shade 200 cutting as well as slat 202 cutting. The handle 101 is used in conjunction with a safety tab 120 connecting the blade cutting arm 101 to the shade cutting machine base 42 and designed to prevent the handle 101 from lifting past the center line 122 of the shade 200 as illustrated in FIGS. 7 and 8. The tab 120 will allow the handle 101 to raise just enough to cut the shade 200, but no further.

The machine 40 further comprises a protective cutting blade guard 102, preferably made of clear plastic, which includes a spring and safety switch (not illustrated) hidden in shade cutting machine base 42 to protect the user, a stationary cutting blade base 124 affixed to the shade cutting machine base 42, and a rotating cutting blade safety cover 126. Preferably the guard 102 is clear plastic to allow the user to witness the slat cutting operation, a protective measure. The guard 102 further includes a tapered cone 128 that, when closed, forms an enclosed circle to protect the user from the cutting blade 100. The guard 102 is used in conjunction with a shut down mechanism comprising a plunger 130 that, when closed, activates a switch (not illustrated) hidden inside the shade cutting machine base 42 of the machine 40. To operate, the user must pull the plunger 130 out with one hand while lowering the safety cover 126 of the guard 102 with the other hand. If the plunger 130 is not pulled out, the safety cover 126 can not be fully depressed and the machine 40 will not be activated. A switch (not illustrated) is enclosed within the machine 40 to prevent accidental activation or intentional bypass of the safety cover 126. A spring (not illustrated) from the shade cutting machine base 42 to the safety cover 126 is designed to allow the operator to lower the safety cover 126 onto the shade cutting machine base. This ensures immediate machine shutdown if the safety cover 126 is released for any reason.

The present invention is also directed to a method for cutting a shade 200, comprising placing an uncut shade 200 in the pin puller 46 (illustrated in FIG. 9) to remove the pin 203 from the shade 200. Next, the shade support bracket 20 is adjusted to the final length of the shade 200. The shade support bracket 20 can be placed at different positions depending on whether the shade 200 will be an inside mount shade 200 or an outside mount shade 200. The slat 202 is then pulled from the shade 200 and positioned on the slat cutter mechanism 23. The shade 200 is then inserted and clamped at the clamping device 90. The cutting blade cover 126 is then lowered. Prior to completely lowering the cutting blade cover 126, a safety pin must be pulled to allow the cutting blade cover 126 to be placed in the appropriate position, which will activate the rotating motor 60. The cutting blade cover 126 must be continued to be physically held down in order to activate the motor 60. This is a safety feature. Once the motor 60 is activated, the shade 200 is then rotated within the bearing assembly 70. The handle 101 is then lifted to cut the rotating shade 200. After the shade 200 has been cut, the cover 126 is lifted to deactivate the rotating motor 60. The handle 101 is then depressed to cut the slat 202. The shade 200 and slat 202 are then removed from the device 10 and reassembled. The shade 200 may then be placed in the pin puller mechanism 46 to reinstall the shade pin 203.

The shade cutter of the present invention overcomes many prior art problems. Of greatest importance, the present invention includes several safety features. Specific advantages of the present invention include that fact that the slat cutter is covered. Therefore, there is no risk of injury to fingers. Further, the opening is larger to accommodate larger diameter shades. Further still, there is only one blade, not two, for cutting both the slat and the shade. The pin puller handle operates at a 180-degree motion, which is an advantage over prior art models which requires nearly a full circular motion. The prior art models must be placed at the edge of a table or bench, which creates safety hazards.

The shade cutter device of the present invention is designed for use by retail customers in “self-service” or other types of retail establishments selling window shades. In this manner, customers can cut custom sized window shades from stock shades having a set width.

The objects and advantages of the invention will appear more fully from the following detailed description of the preferred embodiment of the invention made in conjunction with the accompanying drawings.

### BRIEF DESCRIPTION OF THE DRAWINGS

FIG. 1 is a perspective view of the shade cutter assembly 10 of the present invention.

FIG. 1a is a cross-sectional view of the rail 12 assembly taken along lines 1a-1a of FIG. 1.

FIG. 2 is a perspective view of the shade cutter machine 40 within the shade cutter assembly 10.

FIG. 3 is a side elevated view of the shade cutter machine 40.

FIG. 4 is a partially exploded perspective view of the shade cutter machine 40.

FIG. 5 is a partial perspective view of the shade cutter machine 40 of FIG. 4 focusing on the bearing assembly 70.

FIG. 6 is a second side elevated view of the shade cutter machine 40 with the cover 126 missing.

FIG. 7 is a partial perspective view of the shade cutter machine 40 of FIG. 6 focusing on the clamping device 90.

FIG. 8 is a side elevated view of the shade cutter machine 40 of FIG. 5 with the cover 126 intact.

FIG. 9 is a perspective view of the shade cutter assembly 10 of the present invention illustrating the placement of a shade 200 on the pin puller mechanism 46.

FIG. 10 is a perspective view of the shade cutter assembly 10 of the present invention illustrating the placement of the shade 200 and the shade slat 202 within the cutting machine 40.

### DETAILED DESCRIPTION OF THE INVENTION

Reference is now made to the figures for the following detailed description of the invention as described in the Summary.

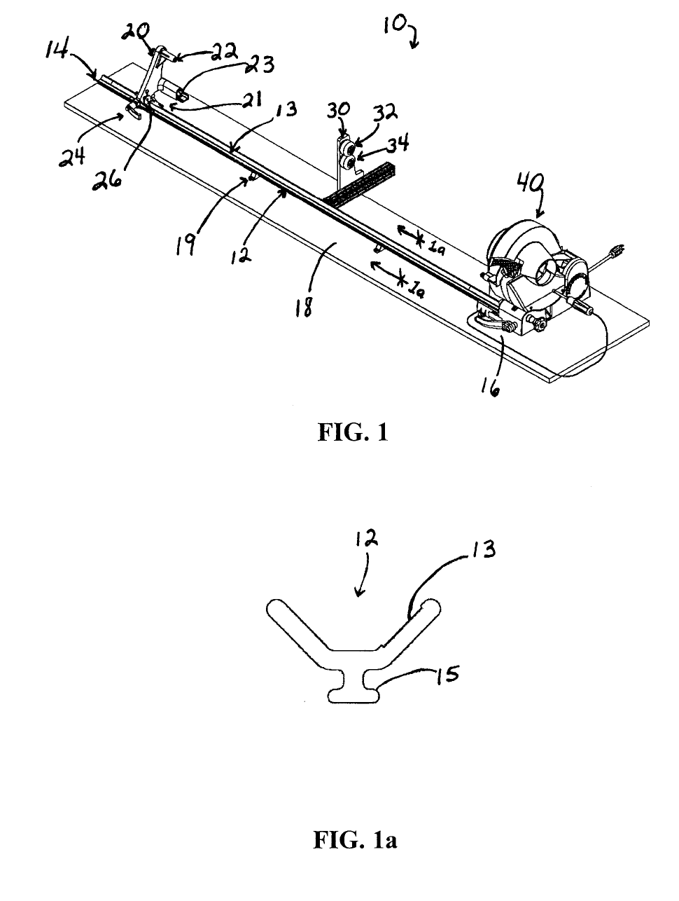

As previously noted, and referring to FIG. 1, the shade cutter assembly device 10 comprises a shade support measuring rail 12 having a first end 14 and a second end 16. The shade cutter assembly device 10 is generally supported on a base 18 by supports 19.

Referring now to FIG. 1a, the rail 12 is configured in a V shape with a T-shaped base 15 on its dorsal side for positioning the rail 12 on the base 18 by means of shade support brackets 19. The base 18 can be made of any of a number of materials, including wood, plywood, plastic, metal or other types of extruded board material. It is also within the scope of the present invention to position the shade cutter assembly device 10 directly on an existing bench or table.

As illustrated in FIG. 1a, a shallow slot 13 extends the length of the rail 12. The slot is ideally suited for the option placement of a measuring tape, such as an adhesive measuring tape (not illustrated), if desired. In this manner, the rail 12 is slotted for precise measuring tape alignment. The measuring tape is printed the length of the slot 13 to measure the shade 200 in order to find the correct spot to cut the shade 200. While the measuring rail 12 can be made of a number of materials, it is preferably made of a lightweight extruded aluminum. The T-shaped base is of a more rigid design allowing for the secure mounting to the shade cutting machine base 42 of the cutting machine 40 as well as to the rail supports 19.

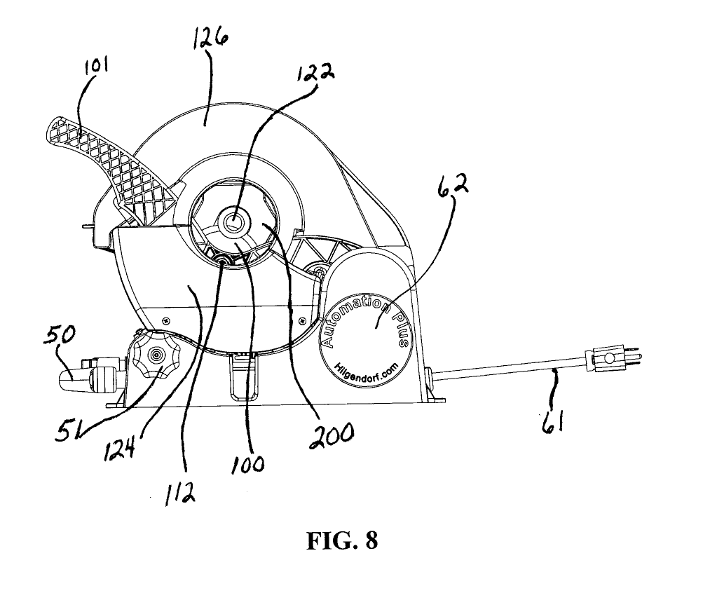

As further illustrated in FIG. 1, the shade support bracket 20 is slidably affixed to the rail 12 by means of glides 21 which slidably interact with the V-shaped confirmation of the rail 12. The shade support bracket 20 comprises a universal inner bearing brace 22 that mates with the shade 200 having both the pin-type and tab-type shade roller ends, therefore minimizing vibrations in the design. The shade support bracket 20 further includes a shade support tightening handle 24 to allow flexibility in the placement of the bracket 20 along with the rail 12. A spring-loaded pin plunger 26 allows the shade pin 201 (illustrated in FIG. 8) to be reinserted without having to move the shade support bracket 20. Thus, the shade support bracket 20 is configured as a one-piece clamping device, which allows easier operation of a shade support as opposed to the prior two-piece clamping designs.

As further illustrated in FIG. 1, an optional vibration dampener 30 is designed to stabilize the shade 200 oscillation during the cutting process. The vibration dampener 30 is adjustable for different size shades 200. The vibration dampener 30 includes counter-rotating wheels 32, 34 to maintain a pressure against the shade 200 as the shade 200 is cut, thereby maintaining the shade 200 in the correct fixed position for cutting. Because the wheels 32, 34 rotate freely on ball bearings (not illustrated), there is no marring or damaging to the shade 200 as the wheels 32, 34 rotate. This results in a cleaner, more controlled cut on the shade 200.

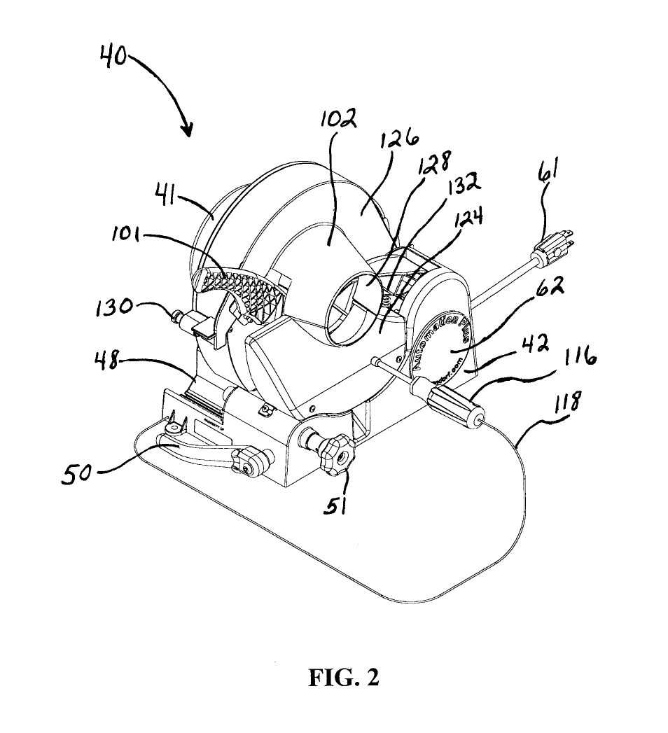

Turning now to FIGS. 2-6, the shade cutting machine 40 has a shade cutting machine base 42, which is designed to be secured to the base 18. It also includes a roller shade slat support 44 for allowing both the shade 200 and the slat 202 to be cut in the same operation, ensuring that both the shade 200 and the slat 202 are of the same length.

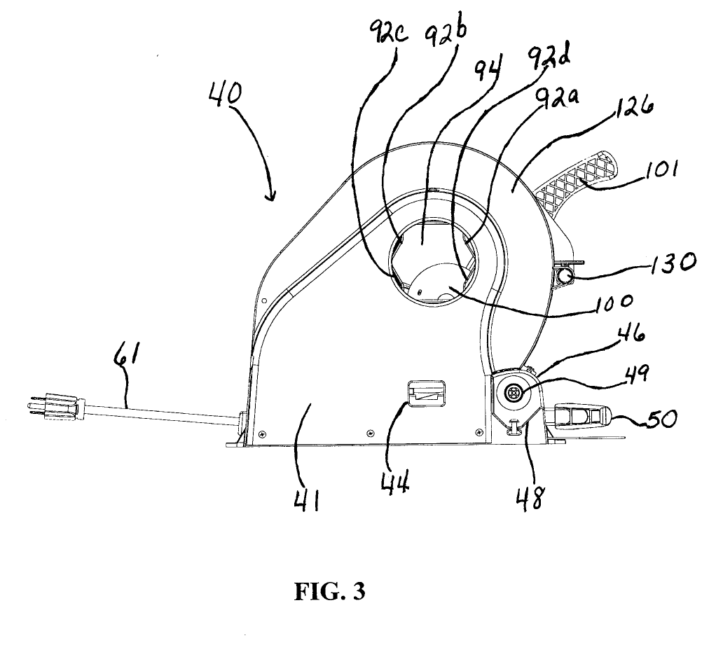

The shade cutting machine 40 also advantageously includes a mechanism for pulling the extension pin from a shade 200. This mechanism includes a shade rest 48, a pin puller handle 50 which is activated in a 180-degree fashion in order to pull the pin (not illustrated) from the end of the shade 200, and a collet 49 within the opening 52. As best illustrated in FIG. 3, the collet 49 is a four-jawed tapered device to clamp the pin of the shade 200 and allow removal. The mechanism is typically of a rack and pinion design and activated by the handle 50. A thumb knob or tightener 51 activates the collet 49 to tighten down on the shade pin 203 on the shade 200.

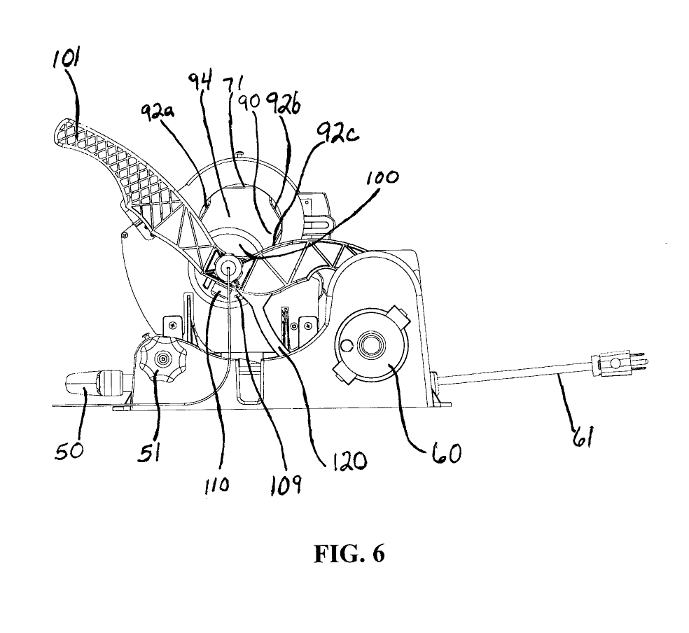

As illustrated in FIG. 2 and FIG. 6, the cutting machine 40 also includes a drive motor 60, which is fully enclosed within the shade cutting machine base 42 of the cutting machine 40. The motor 60 is supported on both ends to reduce vibrations in the machine 40. One end of the motor 60 is securely fastened to the shade cutting machine base 42 with lock nuts or the like. The other end of the motor 60 is secured with a removable closure cap 62 (FIG. 2) that slides over the end of the motor 60 with a press fit. It is within the scope of the present invention to utilize any of a number of motors produced to activate a machine such as the cutting machine 40. One such motor is a DC motor produced by Dumore (Mauston, Wis.).

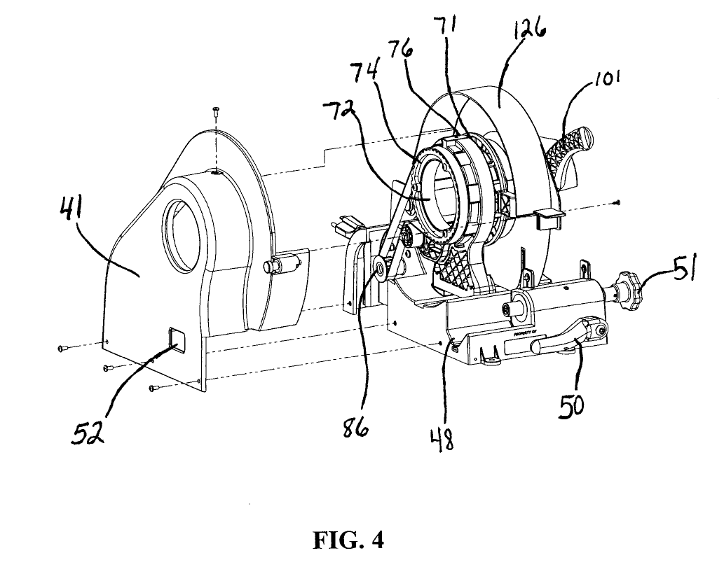

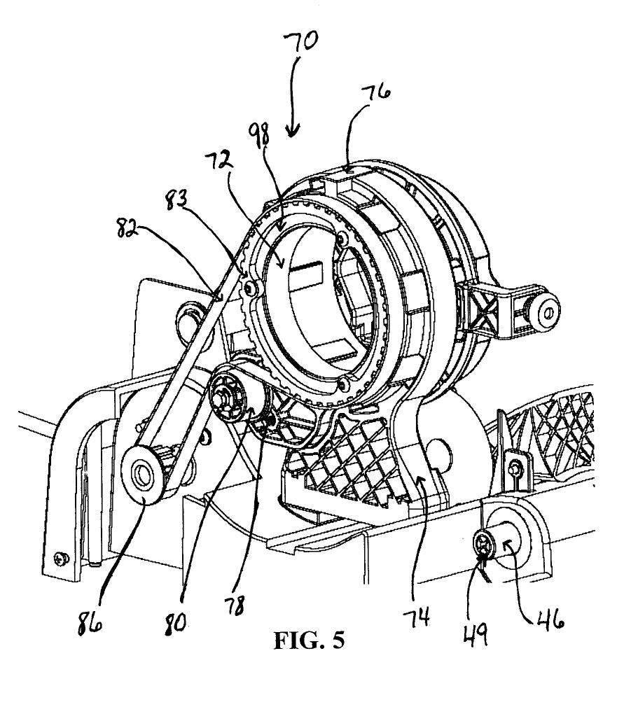

Referring now to FIG. 5, the cutting machine 40 further includes a bearing assembly 70 surrounding the shade clamp assembly 71. The bearing assembly 70 comprises an insert ring 72. Preferably, the insert ring 72 is made from a machined brass ring surrounded by a molded plastic bearing casing 74. Other materials for making the insert ring 72, such as steel, are contemplated. An opening 76 is provided through the top of the casing 74 to allow future oiling of the shade clamp assembly 71, should this be required. The bearing assembly 70 further includes a slot 78 for mounting the timing tensioner 80. This slot 78 ensures proper belt tension at all times. A timing belt 82 and a drive gear 83 are placed on the bearing casing 74 to rotate the shade clamp assembly 71. The timing belt 82 is connected to a smaller sprocket 86, which in turn is rotatably connected to the motor 60 in order to rotate the bearing assembly 70. As illustrated, FIG. 4 is an exploded view of the machine 40 in which a portion of the casing 41 has been removed.

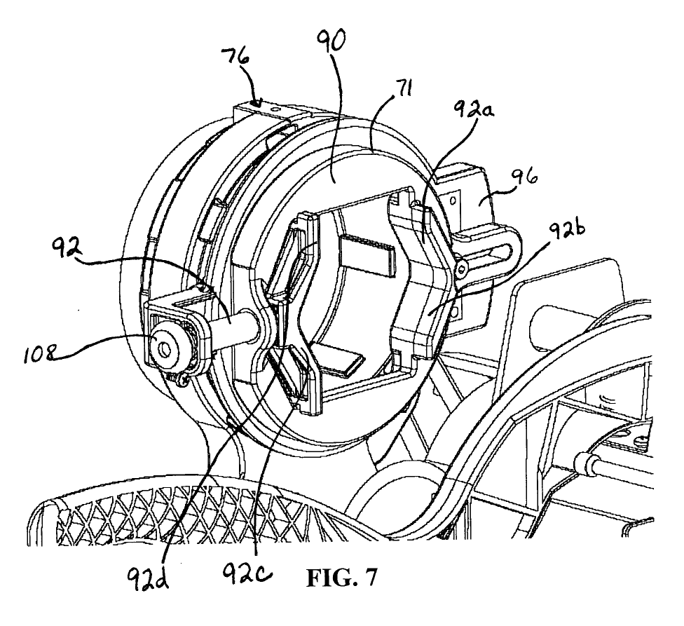

Referring now to FIGS. 6 and 7, the cutting machine 40 further comprises a shade clamp assembly 71 comprising a clamping device 90 which consists of a threadable centering clamp 92 having four centering surfaces 92a, 92b, 92c and 92d such that the shade 200 is clamped in the central portion of the orifice 94. Therefore, the shade 200 is always clamped at four centering surfaces 92a, 92b, 92c and 92d. The centering clamp 92 automatically centers the shade 200 to be cut, thereby minimizing vibrations during the rotation of the shade 200 during the cut. A counterweight 96 (FIG. 7) prevents the clamping assembly 71 from vibrating excessively during rotation. Advantageously, the shade clamp assembly 71 of the present invention is adjustably designed to fit a variety of shade diameters. The shade is clamped with an easy-to-use, attached thumb screw 108, allowing the shade to be fully secured without over tightening that could cause damage to the shade 200 or clamping device 90.

A clamping base 98 (FIG. 5) is made from a machined, preferably brass, ring surrounded by molded plastic and allows for a machined precision fit with the bearing support while dampening vibrations with the molded plastic.

Referring now to FIG. 6 and FIG. 8, the cutting machine 40 further comprises a cutting blade 100 supported by a cutting blade handle 101, comprising a stationary steel blade wherein the blade is preferably a single beveled blade. A protective cutting blade cover 102 (FIG. 2) also includes a spring and safety switch to protect the user. The cutting blade 100 can be rotated at intervals using a spring clip 110 and blade notches 109 on the blade 100, to always have a sharpened portion of the blade 100, available for cutting the shade 200. The cutting blade 100 preferably includes a circular row of eight blade notches 109 spaced out over half the blade 100. It is within the scope of the present invention to include more or less notches 109 as desired. These notches 109 are used in conjunction with a spring steel clip 110 to prevent blade 100 rotation during cutting and allow for quick and easy blade indexing. The spring steel clip 110 attaches directly between the cutting blade handle 101 and the blade 100 using a bolt 112 (FIG. 8). The point of the clip 110 penetrates the blade notch 109 in the blade 100. One side of the clip 110 is perpendicular to the blade notch 109, allowing the blade 100 to stay in a fixed position while cutting the shade 200. The other side of the clip point has been designed with a taper 114 (not illustrated). This allows the operator, using a supplied tool 116 attached to the machine 40 by a flexible tether 118, to advance the blade 100 rotationally to the next slotted position. This exposes a new sharp cutting surface area of the circular blade 100. The notches 109 only cover half of the blade 100. The other half of the blade 100 is used for cutting the slats 202, and may be dull from that operation. Once the user reaches the end of the blade notches 109, it is time to replace the blade 100.

The cutting blade handle 101 is provided for shade cutting as well as slat cutting. The handle 101 is used in conjunction with a safety tab 120 connecting the blade handle 101 to the shade cutting machine base 42 and designed to prevent the handle 101 from lifting past the centerline 122 of the shade 200 as illustrated in FIG. 8. The tab 120 will allow the handle 101 to raise just enough to cut the shade 200, but no further, making the operation as efficient as possible.

The cutting machine 40 further comprises a protective cutting blade guard 102, preferably of a clear plastic or polycarbonate material, which includes a stationary cutting blade base 124 affixed to the shade cutting machine base 42, and a rotating cutting blade cover 126. Preferably, the guard 102 is clear plastic to allow the user to witness the slat cutting operation, a protective measure. The guard 102 further includes a tapered cone 128 that, when closed, forms an enclosed circle to protect the user from the cutting blade 100. The guard 102 is used in conjunction with a shutdown mechanism comprising a plunger 130 that, when closed, activates a switch (not illustrated) hidden inside the shade cutting machine base 42 of the machine 40. To operate, the user must pull the plunger 130 out with one hand while lowering the safety cover 126 with the other hand. If the plunger 130 is not pulled out, the safety cover 126 cannot be fully depressed and the machine 40 will not be activated. A switch (not illustrated) is enclosed within the machine 40 to prevent accidental activation or intentional bypass of the safety cover 126. A spring 132 (FIG. 2) from the shade cutting machine base 42 to the safety cover 126 is designed to allow the operator to lower the cover 126 onto the stationary cutting blade base 124. This ensures immediate machine shutdown if the safety cover 126 is released for any reason.

Unless otherwise specified, all of the materials making the shade cutter assembly device can be of plastic or other composite material. Preferably, materials include glass-filled nylon. Other materials include polycarbonates. It is within the scope of the invention to have all of the materials be of some kind of metal or other material if necessary.

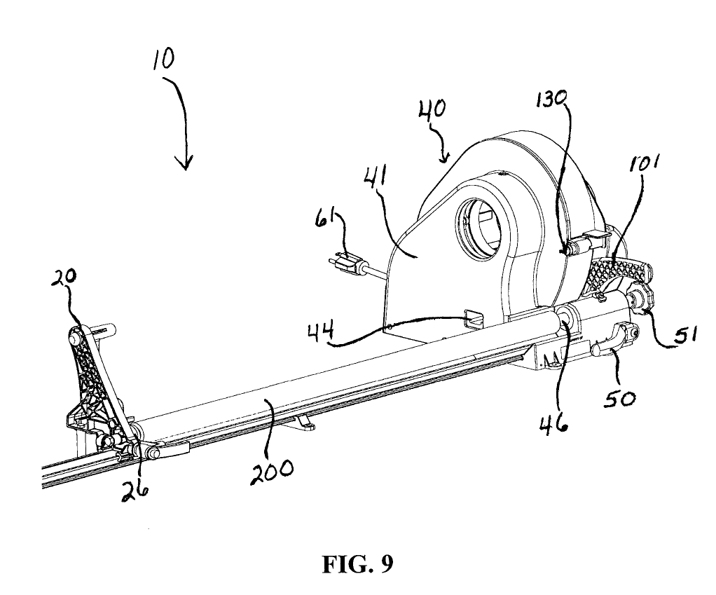

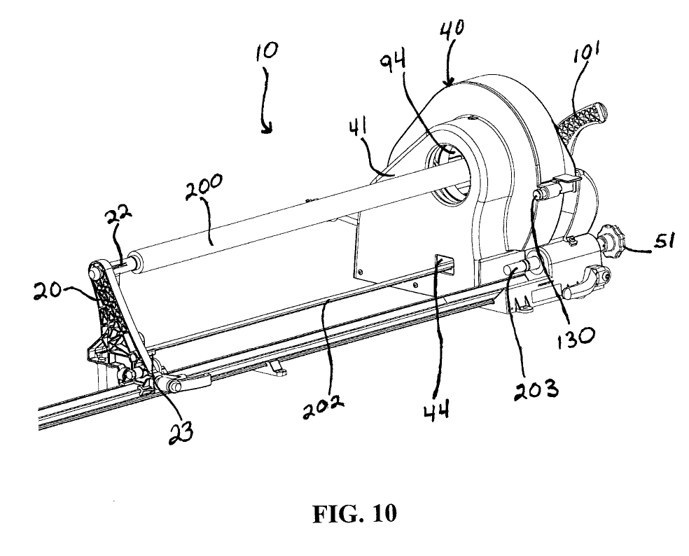

Reference is now made to FIGS. 9 and 10 for a description of the operation of the shade cutter assembly device 10. Referring now to FIG. 9, an uncut shade 200 is placed in the pin puller mechanism 46 to remove the pin from the shade 200. Next, the shade support bracket 20 is adjusted to the final length of the shade 200 utilizing the measuring tape within the rail 12. The shade support bracket 20 can be placed at different positions along the rail 12, depending on whether the shade 200 will be an inside mount shade or an outside mount shade. The slat 202 is then pulled from the shade 200 and positioned within the roller shade slat support 44 of the shade cutting machine 40. The shade 200 is then inserted into the orifice 94 as illustrated in FIG. 10 and affixed to the clamping device 90 (FIG. 7). The cutting blade cover 126 is then lowered. Prior to completely lowering the cutting blade cover 126, the plunger pin 130 must be pulled to allow the cutting blade cover 126 to be placed in the appropriate position, which will then activate the motor 60. The cutting blade cover 126 must be continued to be physically held down with the plunger pin 130 in the pulled position in order to activate the motor 60. This is a safety feature. Once the motor 60 is activated, the shade is then rotated within the bearing assembly 70. The operator then lifts the handle 101, which places the stationary blade 100 against the rotating shade 200 thereby slicing the unwanted length from the shade 200. After the shade 200 has been cut, the cover 126 is lifted to deactivate the rotating motor 60. The handle 101 is then depressed to cut the slat 202 within the roller shade slat support 44. The shade 200 and the slat 202, now both having the same length, are then removed from the cutting machine 40 and the shade cutter assembly 10. The slat 202 is reassembled within the shade 200. The shade 200 is then placed in the pin puller mechanism 26 to reinstall the pin by reversing the operation of the pin puller mechanism 46.

It is understood that the invention is not confined to the particular construction and arrangement of parts herein illustrated and described, but embraces such modified forms thereof that fall literally or equivalently within the scope of the following claims.

What is claimed is:

1. A shade cutter assembly device for trimming a rotating window shade and a window shade slat to a precise dimension, comprising:
a. a shade support measuring rail having a length extending from a first end to a second end;
b. a shade support bracket slidably affixed to the rail;
c. a shade cutting machine, comprising
i. a shade cutting machine base;
ii. a roller shade slat support for allowing both the shade and the slat to be cut in the same operation;
iii. a drive motor;
iv. a shade clamp assembly which includes a clamping device for affixing the window shade to the shade cutting machine;
v. a bearing assembly surrounding the shade clamp assembly, the bearing assembly being operated by the drive motor for rotating the shade clamp assembly;
vi. a cutting blade handle comprising a single, stationary cutting blade for cutting both the rotating window shade and the window shade slat;
vii. a protective cutting blade cover; and
viii. a protective cutting blade guard.

2. The shade cutter assembly device of claim 1 wherein the device is supported on a base by supports.

3. The shade cutter assembly device of claim 1 wherein shade clamp assembly includes a threadable centering clamp.

4. The shade cutter assembly of claim 1 wherein the rail includes a shallow slot extending along the length of the rail.

5. The shade cutter assembly of claim 4 wherein a measuring device is placed in the slot.

6. The shade cutter assembly of claim 1 wherein the shade support bracket comprises glides to slidably interact with the rail.

7. The shade cutter assembly of claim 1 wherein the shade support bracket comprises a spring loaded pin plunger for placement of shade on the shade support bracket.

8. The shade cutter assembly of claim 1 further comprising a vibration dampener affixed to the rail.

9. The shade cutter assembly of claim 1 wherein the roller shade slat support comprises a pin puller mechanism which includes a slat opening, a 180-degrees pin puller handle, and a collet clamp a pin of the shade for removal of the pin.

10. The shade cutter assembly of claim 1 wherein the bearing assembly comprises an insert ring and a belt to rotate the shade clamp assembly.

11. The shade cutter assembly of claim 1 wherein the protective cutting blade cover comprises a safety switch to protect the user.

12. The shade cutter assembly of claim 1 comprising means for rotating the blade at intervals.

13. The shade cutter assembly of claim 12 wherein the means for rotating the blade comprises a plurality of notches in spaced relationship on the blade.

14. The shade cutter assembly of claim 1 wherein the cutting blade handle comprises a safety tab connecting the handle to the shade cutting machine base.

15. The shade cutter assembly of claim 1 wherein the protective cutting blade guard comprises a stationary cutting blade base affixed to the shade cutting machine base and a rotating cutting blade cover.

16. The shade cutter assembly of claim 15 wherein the protective cutting blade guard is made from clear plastic to allow the user to witness the slat cutting operation

17. The shade cutter assembly of claim 1 wherein the protective cutting blade guard comprises a tapered cone that, when closed, forms an enclosed circle to protect the user from the cutting blade.

18. The shade cutter assembly of claim 1 wherein the protective cutting blade guard comprises a shut down mechanism.

19. A shade cutting machine for a shade cutter assembly device, comprising a shade cutting machine base; a roller shade slat support for allowing both the shade and the slat to be cut in the same operation; a drive motor; a shade clamp assembly comprising a clamping device consisting of a threadable centering clamp; a bearing assembly surrounding the shade clamp assembly for rotating the shade clamp assembly; a cutting blade comprising a single, stationary blade; a protective cutting blade cover; a cutting blade handle; and a protective cutting blade guard.

20. A method for cutting an uncut shade with a slat and at least one end pin to a precise length in a shade cutter assembly device which includes a shade support measuring rail, a shade support bracket slidably affixed to the rail and a motor-driven shade cutting machine which includes a slat cutter device, a shade clamping device, a bearing for rotating the shade, a single blade for cutting both the shade and the slat, and a safety blade cover for the blade wherein the safety blade cover includes a safety switch which must be activated by lowering the safety blade cover over the blade before motor-driven shade cutting machine can be activated, comprising:
a. removing the end pin from the uncut shade;
b. adjusting the shade support bracket on the rail to a desired final length for the uncut shade;
c. removing the slat from the uncut shade;
d. positioning the slat on the shade support bracket and the slat cutting device;
e. positioning the inserting the shade on the shade support bracket and the shade clamping device;
f. lowering the safety blade cover to activate the motor-driven shade cutting machine;
g. rotating the uncut shade within the bearing assembly;
h. lifting the blade to cut the rotating shade;
i. raising the safety blade cover to deactivate the rotating motor;
j. depressing the handle to cut the slat; and
k. removing and reassembling the shade, slat and end pin.
